(19) United States
(12) Patent Application Publication
(10) Pub. No.: US 2013/0246080 A1
(43) Pub. Date: Sep. 19, 2013

(54) Generating Policy Summaries From Logic Code

(71) Applicants: Aharon Abadi, Eilat (IL); Bnayahu Jonathan, Haifa (IL); Feldman Yishai, Tel Aviv (IL); Moti Nisenson, Haifa (IL); Yahalomit Simionovici, Moshav Kerem Maharal (IL)

(72) Inventors: Aharon Abadi, Eilat (IL); Bnayahu Jonathan, Haifa (IL); Feldman Yishai, Tel Aviv (IL); Moti Nisenson, Haifa (IL); Yahalomit Simionovici, Moshav Kerem Maharal (IL)

(73) Assignee: INTERNATIONAL BUSINESS MACHINES CORPORATION, Armonk, NY (US)

(21) Appl. No.: 13/423,289

(22) Filed: Mar. 19, 2012

(51) Int. Cl. G06Q 50/22; G06Q 40/08

(52) U.S. Cl. CPC G06Q 50/22; G06Q 40/08
USPC 705/2; 705/4

(57) ABSTRACT

Systems and methods for presenting benefit rules in a policy into a human readable table are provided. The method comprises analyzing logic code implemented for processing claims under a policy to identify one or more rules and one or more parameters of interest; translating the rules, as applicable to the parameters of interest, into an ordered list of boolean expressions; applying an algorithm to the ordered list of boolean expressions to identify a solution for a set of query parameters defined by the rules and the parameters of interest; and generating a summary table according to the identified solution for the set of query parameters.

### COPYRIGHT & TRADEMARK NOTICES

A portion of the disclosure of this patent document may contain material, which is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of the applicant, the assignee or third parties affiliated or unaffiliated with the applicant or the assignee. Use of these marks is for providing an enabling disclosure by way of example and shall not be construed to exclusively limit the scope of the disclosed subject matter to material associated with such marks.

### TECHNICAL FIELD

The disclosed subject matter relates generally to generating policy summaries and, more particularly, to a system and method for generating policy summaries from a logic code used to implement the policy.

### BACKGROUND

In the insurance industry, particularly in the field of healthcare, understanding of the coverage policies is notoriously difficult, not only for the insured but also for the healthcare providers and the insurers. For that reason, most insurers provide shortened summaries of the main sections of the insurance policy.

The manual creation of these summaries is slow, costly and error-prone. As policies are renewed and updated, the summaries have to be updated accordingly. Further, summary formats and the information to be included may change due to revisions or new regulations, making the manual creation of the summaries even more tedious.

Automated policy generation solutions that are based on heuristics exist, but unfortunately these solutions provide inaccurate results. An automated system that provides an accurate and quick understanding of the benefit rules can help avoid many coverage mistakes and will also help providers to advise the insured with accurate coverage information.

### SUMMARY

For purposes of summarizing, certain aspects, advantages, and novel features have been described herein. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested herein.

In accordance with one embodiment, a method for presenting benefit rules in a policy into a human readable table comprises analyzing logic code implemented for processing claims under a policy to identify one or more rules and one or more parameters of interest; translating the rules, as applicable to the parameters of interest, into an ordered list of Boolean expressions; applying an algorithm to the ordered list of Boolean expressions to identify a solution for a set of query parameters defined by the rules and the parameters of interest; and generating a summary table according to the identified solution for the set of query parameters.

In accordance with one or more embodiments, a system comprising one or more logic units is provided. The one or more logic units are configured to perform the functions and operations associated with the above-disclosed methods. In yet another embodiment, a computer program product comprising a computer readable storage medium having a computer readable program is provided. The computer readable program when executed on a computer causes the computer to perform the functions and operations associated with the above-disclosed methods.

One or more of the above-disclosed embodiments in addition to certain alternatives are provided in further detail below with reference to the attached figures. The disclosed subject matter is not, however, limited to any particular embodiment disclosed.

### BRIEF DESCRIPTION OF THE DRAWINGS

The disclosed embodiments may be better understood by referring to the figures in the attached drawings, as provided below.

FIG. 1 illustrates an exemplary summary table, in accordance with one or more embodiments, generated from the logic code that includes the rules and parameters for a policy of insurance.

FIG. 2 illustrates examples of sequential conditional clauses that may be produced from a logic code that includes the rules and parameters for a policy of insurance, in accordance with one embodiment.

FIGS. 3A, 3B and 3C are exemplary algorithms for finding one or more rules that satisfy a constraint satisfaction problem formulated based on the rules and parameters in logic code used for claims adjudication, in accordance with one embodiment.

FIG. 4A is an unminimized truth-table generated based on the legal assignments of parameters of interest and the outcome generated from application of an algorithm that finds a solution to a constraint satisfaction problem implemented according to the rules and parameters for a policy of insurance in accordance with one embodiment.

FIG. 4B is a minimized version of the truth-table of FIG. 4A, in accordance with one embodiment.

FIG. 5 is a summary table generated from the minimized truth-table of FIG. 4A and made as readable as possible by hiding certain information in the headings of the table, in accordance with one embodiment.

FIGS. 6 and 7 provide exemplary results that show the advantages of utilizing either Algorithm 1 or Algorithm 2, in accordance with one or more embodiments.

FIGS. 8A and 8B are block diagrams of hardware and software environments in which the disclosed systems and methods may operate, in accordance with one or more embodiments.

Features, elements, and aspects that are referenced by the same numerals in different figures represent the same, equivalent, or similar features, elements, or aspects, in accordance with one or more embodiments.

### DETAILED DESCRIPTION OF EXAMPLE EMBODIMENTS

In the following, numerous specific details are set forth to provide a thorough description of various embodiments. Certain embodiments may be practiced without these specific details or with some variations in detail. In some instances, certain features are described in less detail so as not to obscure other aspects. The level of detail associated with the elements or features should not be construed to qualify the novelty or importance of one feature over the others.

A source that contains the coverage information for an insurance policy in a formal and machine-readable form is the logic code that controls how insurance claims are paid. As such, insurance coverage summaries, in one embodiment, may be created from the logic code that implements the payment mechanism in a computing environment.

For the purpose of example, in the following, policies in the pharmaceutical space are used as a means to disclose features and elements of the claimed subject matter, for the reason that such policies are simpler than general medical benefit policies and thus may be more easily illustrated and understood. It is noteworthy, however, that the disclosed details should not be construed as limiting the scope of the claimed subject matter to the pharmaceutical space.

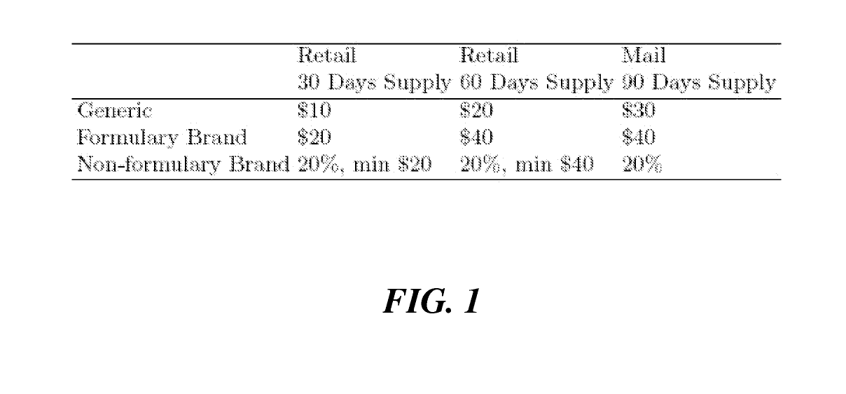

Referring to FIG. 1, an exemplary summary is provided that illustrates two purchase options (i.e., service types) that may be available under a policy of coverage. Retail purchase option, as shown, means that the drug was purchased at a retail location (e.g., a pharmacy). Mail option, means that the drug was mailed to the insured. The term “days supply” refers to the amount of the drug supplied, in terms of the number of days it is supposed to last. The dollar values indicate the applicable copayment, for example.

As shown, the first column of results applies to a drug purchased in a pharmacy, in an amount sufficient for at most 30 days. If a larger amount is purchased at the pharmacy, e.g., up to a 60-day supply, the results in the second column apply. Larger amounts are not covered at a pharmacy. In contrast, drugs purchased by mail may include a supply of up to 90 days, and the results in the third column apply in this case.

The example summary in FIG. 1 also refers to several groups of drugs. There is a list of formulary drugs, which are covered at a reduced cost to the insured—in some countries these may be referred to as belonging to a “basket of covered drugs,” which may be regulated. Brand drugs are usually more expensive than generic drugs, which are clinically equivalent to the brand drug but produced by other companies once the original patents have expired.

As noted, the values in the example summary indicate the copay amount (i.e., the amount an insured is to pay for the drug in the given circumstances). For example, the value “20%, min $20” indicates the insured is to pay 20% of the cost of the drug, but no less than $20 or the actual cost, whichever is lower. A row of the summary table is called a tier. Various numbers of tiers are possible, depending on the details of the policy. The example of FIG. 1 illustrates three tiers: Generic, Formulary, and Non-formulary brands.

Some policies may have additional tiers for specific groups of drugs. Common examples are specialty drugs, expensive drugs, and injectable drugs. The simplest policy would have a single tier called All. We note that this could be just one part of a larger summary, which may include such details as which drugs are covered and which are not. Policies and claim adjudication systems that may be represented in sequential conditional order in the manner provided below may be good candidates for generating a summary table:

if (F1) then Result1;
else if (F2) then Result2;
else if (F3) then Result3;
...
else if (Fn) then ResultN,
where Fn is equivalent to TRUE.

We note that atomic boolean predicates in the logic code may be replaced with boolean variables. Thus, a boolean variable A may represent the predicate “Drug Type is Generic”, for example. We also can derive boolean constraints (e.g., if the boolean variable B=‘Days Supply>30’ and the boolean variable C=‘Days Supply>60’ then C->B). Thus, in this representation, a function F is a boolean expression over boolean variables, and there is an additional formula C giving the constraints.

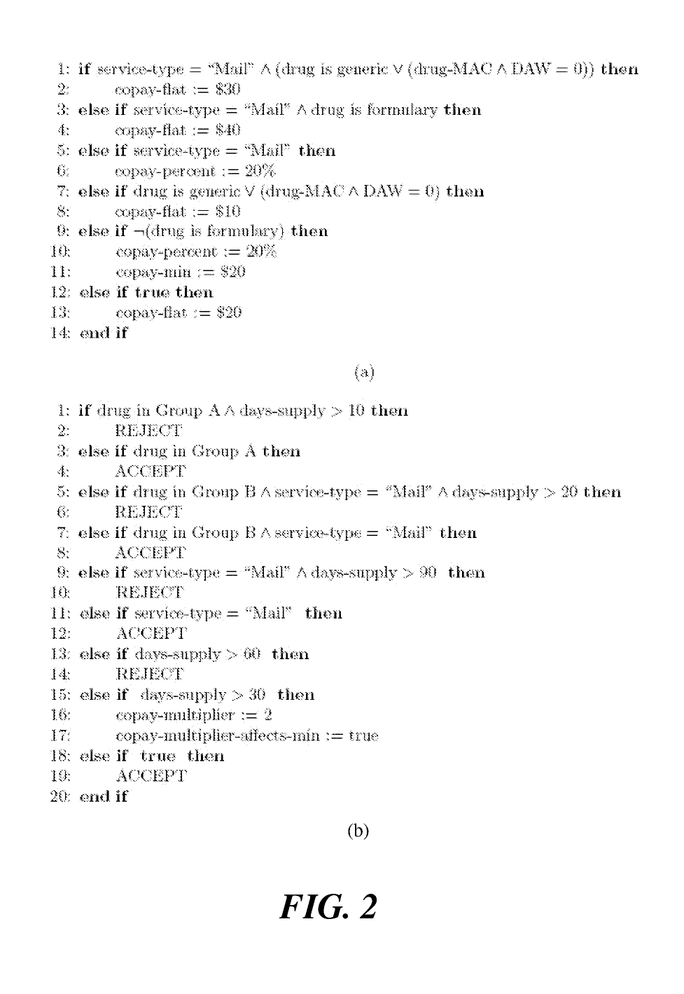

In the following, one or more embodiments are disclosed by way of example as relating to a “copay summary” as it is one of the more complex parts of the summary to extract from the code. Policy implementations may use a variety of languages and technologies. For example, the policy may be expressed as a set of tables, which are interpreted by a runtime system. For simplicity, the example of FIG. 1 is translated into pseudo-code form, shown in FIG. 2. For the purpose of example, let us assume that an exemplary claims-adjudication system includes a sequence of rules that includes one or more logical conditions and a corresponding outcome.

In this example, the last condition of the policy is true, so that an outcome is defined. In accordance with one embodiment, policy implementations are broken down into various stages, which are run in sequence. For example, one stage may validate the claim input, another stage may check whether the insured needs prior authorizations for the drugs (as is common for costly drugs), a third stage may calculate how much the insured is to pay, and a fourth stage may apply various limits, such as the insured's maximum out-of-pocket payments for the year.

For the sake of brevity, we discuss below two exemplary stages. The first stage, as shown in FIG. 2(a), is a payment stage for calculation of an initial copay specification. The second stage, as shown in FIG. 2(b), is a dispensing stage to determine limits based on the amount of drug dispensed, for example. In the second stage, the copay specification may be altered by multiplying or adding to its components.

It is noteworthy that the codes shown in FIG. 2 refer to variables that did not appear in the summary table of FIG. 1 because not all variables were selected as interesting variables for the purpose of the summary in FIG. 1. For example, the drug-MAC variable, which indicates whether the drug has a Maximum Allowable Cost, or the DAW (Dispense-As-Written) variable that encodes the reason for a brand drug being dispensed instead of a prescribed generic drug participate in the decision but are not shown in the summary.

In one embodiment, given a set of target or interesting variables that participate in the summary, a method is implemented to determine the correct result for a combination of interesting variables in the table. Because other variables that are not targeted may influence the result, multiple possible results for a combination of values of the interesting variables may be generated as provided in more detail below.

For the purpose of example, in one embodiment, depending on implementation, a general rule in the logic code (e.g., the most general rule), which is the one that is to be covered in the generated summary is assumed to be the last rule that applies to any assignment to the interesting variables. For instance, consider a benefit coder who is trying to add a new special case, such as an exception for the case of a new medication, called WonderDrug, to an existing policy. There may be several existing rules that currently apply to WonderDrug.

For example, one rule may refer to a drug group that contains the WonderDrug, and one rule may apply to drugs that have no other exceptions. If the coder puts the new rule at the end, the code will also need to modify the first two rules by adding the condition that the drug is not the WonderDrug, otherwise one of the original rules will be applied and the new rule will be ignored. In contrast, if the new rule is placed before the existing ones, the older rules require no change, since the new rule takes precedence over them. Because it is more economical for coders to put exceptions before general cases, it is assumed in one embodiment that the most general rule is positioned last.

Based on the above, a set of rules may be given as a sequence F1 . . . Fn of formulas over the boolean variables x1 . . . xk, and an associated sequence R1 . . . Rn denoting the corresponding results for the policy. Ri is the result that applies to a given assignment to x₁ . . . xₖ such that Fᵢ is the first formula that evaluates to true for that assignment. In one embodiment, it is assumed Fn is true, so that the result is well-defined.

Because some of the original policy variables are not boolean, the variable may be encoded using boolean variables. Depending on implementation, the encoding may be performed in a different manner based on the type of the original variable. For example, the variable “days-supply” may be encoded as an integer value. By inspecting the policy, it may be determined that certain ranges of values are relevant. Therefore, the days-supply may be encoded using five boolean variables corresponding to the ranges [0,10], [0,20], [0,30], [0,60], [0,90] (e.g., these ranges are represented by the predicates “days-supply≦10”, “days-supply≦20” and so on).

One or more assignments to the variables may be inconsistent with the interpretation of days-supply. Thus, it is assumed that we are given a constraint formula C that defines the legal assignments for x1 . . . xk; that is, those that correspond to feasible assignments to the original policy variables. The formula C is automatically computed by the algorithm that translates policy predicates to boolean variables.

As explained above, in one embodiment, it is desirable to find the most general result for an assignment to the interesting variables, which without loss of generality is assumed to be a prefix x1 . . . xm of the list of variables for m<k. A given assignment “s” to the interesting variables may have several legal extensions to assignment over the variables; we denote this set of full assignments by SC(s). or S1(s) . . . Si−1(s) such that:

Sᵢ(s) [symbol] {s′εS^{C}(s)\(S₁(s)∪ . . . ∪Sᵢ₋₁(s))|s′|=Fᵢ}.

The sets S1(s) . . . Sn(s) are defined to be a partition of SC(s), where Si(s) corresponds to the subset of assignments in SC(s) that do not satisfy F1 . . . Fi−1 but do satisfy Fi. If S1(s) . . . Si−1(s) have already been defined, then:

Sᵢ(s) [symbol] {s′εS^{C}(s)\(S₁(s)∪ . . . ∪Sᵢ₋₁(s))|s′|=Fᵢ}.

In this definition, an empty union is considered to be an empty set. In this context, satisfiability (often written in capitals or abbreviated SAT) is the problem of determining if the variables of a given Boolean formula can be assigned in such a way as to make the formula evaluate to TRUE.

In one implementation, it is determined whether no such assignments exist, which would imply that the function expressed by the formula is identically FALSE for possible variable assignments. In this latter case, we would say that the function is unsatisfiable, otherwise it is satisfiable. For example, the formula “a AND b” is satisfiable because one can find the values a=TRUE and b=TRUE, which make “a AND b” TRUE.

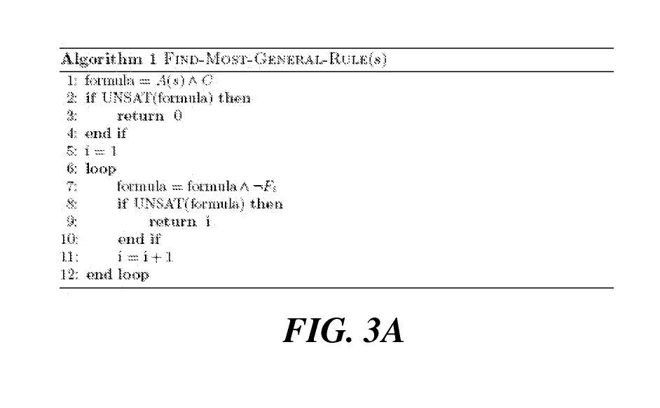

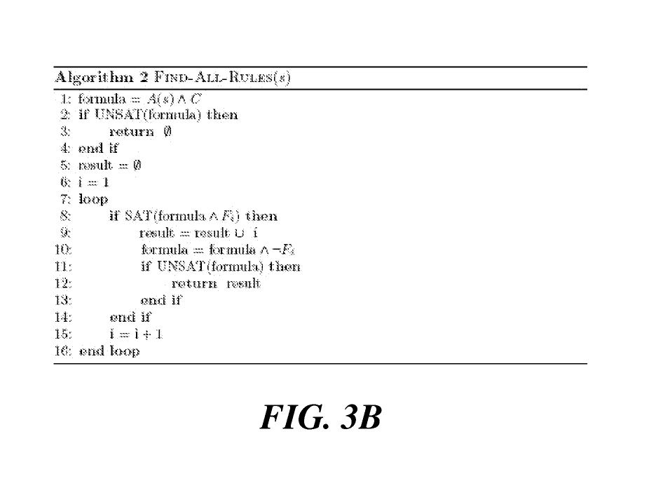

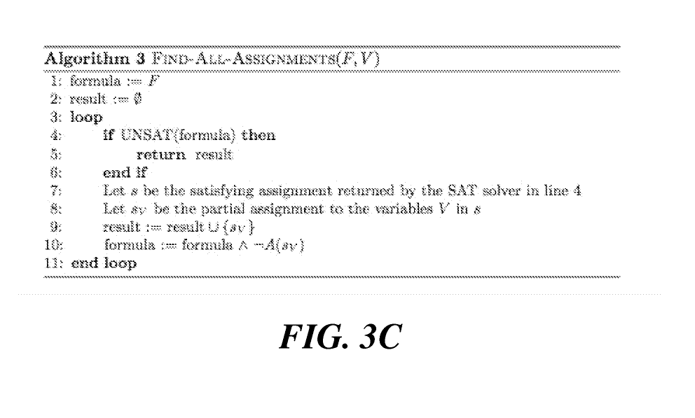

Referring to FIG. 3A, in accordance with one embodiment, the most general rule for “s” would be Fᵢ such that Si(s) !={ } but Sj(s)={ } for i<j≦n. In order to populate the summary table, the most general rule for an assignment “s” to the interesting variables is calculated. As shown, in Algorithm 1, the number of the most general rule for an input assignment “s” of the interesting variables may be calculated according to Algorithm 1. In the formula A(s) [symbol] C, A(s) is the straightforward translation of the assignment “s” into a formula, and C is the constraint.

Assignments that violate the constraint are illegal, and the algorithm returns 0 to denote that. Otherwise, the algorithm conjoins the negation of a rule Fᵢ in turn, until the formula is unsatisfiable. At that point, we know that there is no way for any extension of “s” to pass rule Fi, so that this is the most general rule according to our definition.

In some cases, finding the most general rule is not enough, because it is desirable to also determine which special cases or exceptions to that rule exist. These exceptions are the rules Fᵢ such that Si !={ }, except for the last one (which is the most general). In order to find the exceptions, we need to modify the algorithm to keep track of the rules that are satisfiable by an extension of the assignment “s”. Referring to FIG. 3B, Algorithm 2 returns a set of numbers for the rules whose conditions are satisfied; the highest-numbered rule is the most general case, and the others are the exceptions.

Algorithm 2, in one embodiment, checks the satisfiability of a rule (in conjunction with the negation of the previous ones). As such, it is possible to ignore those rules that are unsatisfiable under the given assignment. Accordingly, the addition of Fᵢ to the formula in line 10 of Algorithm 2 is performed when the rule is found to be satisfiable (in line 8). The following lemma states that this optimization is correct; in other words, the most general rule returned by both algorithms is the same.

Lemma 1. Let m be the result of Algorithm 1 on assignment “s”, and let R be the result of Algorithm 2 on the same input. If m=0, then R={ }. Otherwise, the largest element in R is “m”. Proof. “m” is 0 if A(s) [symbol] C is unsatisfiable, in which case R={ }. If m !=0, then A(s) [symbol] C is satisfiable. Since Fn=true, Algorithm 1 will terminate, and “m” is well-defined. We define fⱼ and gⱼ to represent the values of the “formula” variable at the j-th iteration in Algorithms 1 and 2, respectively:

$${f}_{j} {=}^{Δ} \{ \begin{matrix}A ( s ) ⋀ C & if j = 0 \\ {f}_{j - 1} ⋀ - {F}_{j} & otherwise\end{matrix} \\ {g}_{j} {=}^{Δ} \{ \begin{matrix}A ( s ) ⋀ C & if j = 0 \\ {g}_{j - 1} ⋀ - {F}_{j} & if SAT ( {g}_{j - 1} ⋀ {F}_{j} ) \\ {g}_{j - 1} & otherwise\end{matrix}$$

It can be proven by induction that fⱼ=gⱼ for 0≦j≦m. Clearly, f0≡A(s) [symbol] C≡g0. Assume that i<m, and that the statement is correct for j≦i; then it can be shown that it holds for i+1. First, note that SAT(fⱼ) for j≦i (since Algorithm 1 returned the value m, it could not have terminated earlier). By our assumption, SAT(gⱼ) for j≦i, and thus Algorithm 2 also has not yet terminated. If SAT(gⱼ [symbol] Fᵢ₊₁), then gᵢ₊₁≡gᵢ [symbol] Fᵢ₊₁≡fᵢ [symbol] Fᵢ₊₁. Otherwise, UNSAT(gⱼ [symbol] Fᵢ₊₁), and so gᵢ₊₁≡gᵢ≡gᵢ [symbol] Fᵢ₊₁≡fᵢ [symbol] Fᵢ₊₁≡fᵢ₊₁.

We have shown that fⱼ≡gⱼ for 0≦j≦m. Therefore, SAT(fⱼ) [symbol] SAT(gᵢ) for 0≦j≦m. Thus, SAT(gₘ₋₁) and UNSAT(gₘ), so that gₘ!≡gₘ₋₁, which implies SAT(gₘ₋₁ [symbol] Fₘ). Therefore, m is added to R in Algorithm 2. Because UNSAT(gₘ), the algorithm terminates at that point, and “m” is therefore the largest element of R.

In order to determine the final resulting copay for an assignment, the results from both the copay and dispensing stages are considered. For example, the copay-multiplier is applied to the copay-flat value calculated in the copay stage. Because the dispensing stage can reject some assignments, an analysis may be first performed over the dispensing stage, and then over the copay stage. During the dispensing stage, the interesting variables in that stage are considered to generate fewer partial assignments to be passed to the algorithm for the copay stage.

The partial assignments are then extended to cover the additional interesting variables defined in the copay stage before being passed to the algorithm once more for the formulas in that stage. The advantage of this approach lies in that the summary table does not include any rejected results. Thus, if a partial assignment is rejected during the dispensing stage, extensions to it are not considered in the copay stage, improving overall performance.

Since many assignments may not be consistent with the constraint C, blindly iterating over possible partial assignments is inefficient. Instead, in one embodiment, a SAT solver may be used to enumerate the unique assignments satisfying a formula F over the set V of interesting variables, as shown in Algorithm 3 of FIG. 3C. For the dispensing stage, Algorithm 3 is called with F=C. For the copay stage, it is called for the non-rejected partial assignment s_{d} found in the dispensing stage with F=C [symbol] A(s_{d}).

In practice, the update in line 10 can be performed directly to the SAT solver by adding [symbol] s_{V} as a blocking clause, thus preserving the information that the solver has already learned. The method used may be further optimized by using an all-solutions SAT solver. When generating assignments in this fashion, the tests for the satisfiability of the formula in the beginning of Algorithms 1 and 2 may be removed.

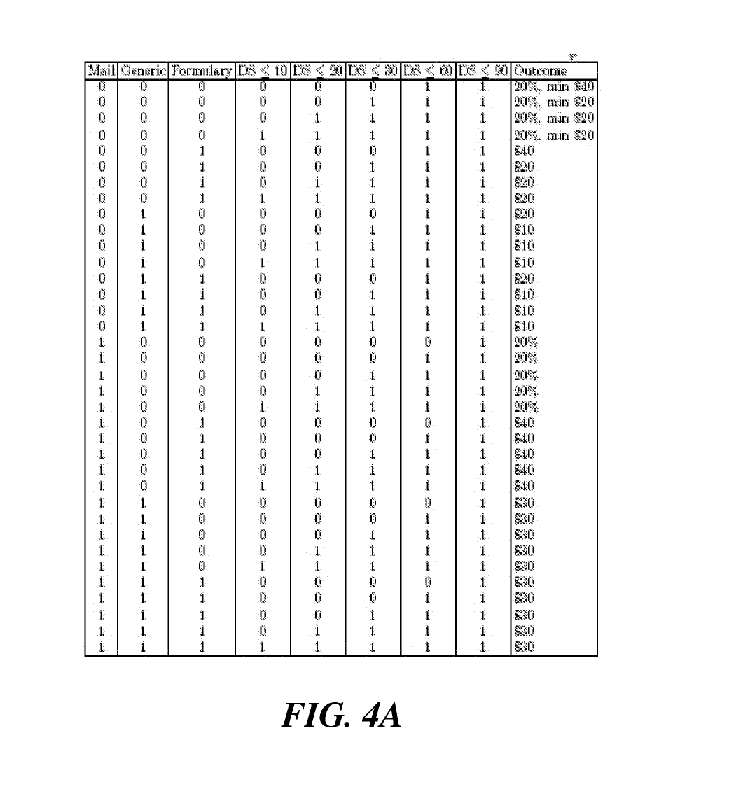

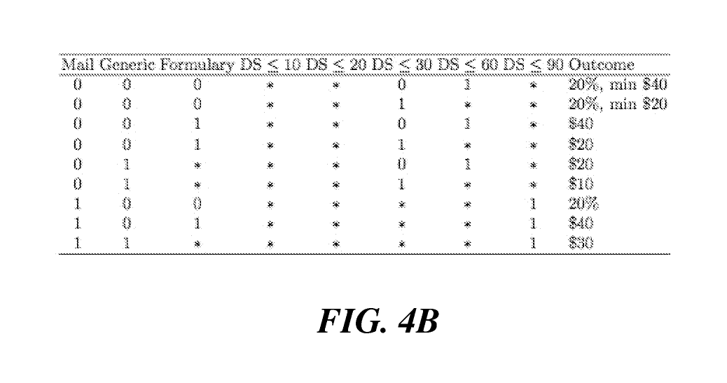

Referring to FIG. 4A, by way of example, given the legal assignments and corresponding outcomes, an unminimized truth-table with the outcome of an assignment may be generated. The last column (i.e., the right most column) in the exemplary table of FIG. 4A, represents the output generated by the application of one or more of the above algorithms to the values in the preceding columns, where the values in a row represent the partial assignment to the interesting variables that cover the conditions in the code illustrated in FIG. 2.

In the exemplary unminimized table shown in FIG. 4A, 48 entries are generated. In order to prepare the summary table illustrated in FIG. 1 from the unminimized truth-table of FIG. 4A, the following processes may be performed, in accordance to one embodiment: (1) create a minimized truth-table; (2) identify services; (3) determine sub-service columns; (4) identify tiers; (5) determine cell-contents; and (6) combine identical tiers.

Minimizing the truth-table may be accomplished by replacing a unique outcome by its own Boolean variable, and then applying logic-minimization techniques that are known in the art. When performing the minimization, the negated constraint, [symbol] C, is used to provide don't-care values since illegal claims do not need to be represented in the summary.

Referring to FIG. 4B, a minimized truth-table is illustrated in which asterisks are used to indicate don't-cares. As shown, the 48 entries of the unminimized table may be reduced to nine entries in this exemplary illustration.

Thereafter, the correct row and column headings for the summary are identified. Referring to FIG. 1, in this example, the rows of the table correspond to tiers, and the columns correspond to service types. The columns may further be subdivided by other predicates, such as those related to days-supply (“DS”; e.g., DS<=10, DS<=20, etc.).

Services may be complex. To better understand, consider an example in which a certain pharmacy chain (e.g., CheapDrugsByMail) is designated as a low-cost mail service. In this case, relevant rules may stipulate both that the pharmacy chain is CheapDrugsByMail and the service-type is “Mail.” Thus, to extract the actual services, we need to consider the assignments to the service variables that actually occur in the minimized truth-table.

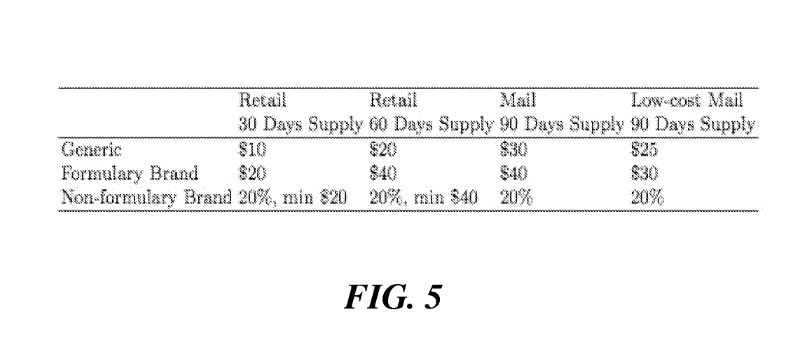

Referring to FIG. 5, in one embodiment, the summary table may be made as readable as possible by hiding certain information in the headings. As shown, the column labeled “Mail” is in fact equivalent to “Mail and pharmacy chain isn't CheapDrugsByMail.” The choice not to display certain information is based on an understanding of the domain, if to those who view the table it is obvious that “Low-cost Mail” is an exception to the “Mail” column without the exceptions having to be specified explicitly.

After discovering the services that actually appear in the table, the services are separately analyzed to determine the sub-service columns for the target service. As an example, for the variable days-supply, any range of values of days-supply may be represented by one or two literals. A single literal may represent an unbounded interval such as “days-supply≦10” or “days-supply>90.” Two literals may represent bounded ranges like “20<days-supply≦60”. For any such range, the other variables may be removed during the minimization.

For example, “20<days-supply” implies “10<days-supply,” and “days-supply≦60” implies “days-supply≦90.” If the results within a range are identical, then the minimization will indeed remove rows corresponding to sub-ranges. Thus, after minimization, the Boolean variables corresponding to days-supply may have at most one 0 value and at most one 1 value in a row in the truth table. The lower end of a range may be omitted in the table headings, for example, if it is the upper bound of the previous range, and can be readily inferred from the table.

The tiers are simply identified by examining the assignments to tier-variables in one or more rows in the minimized table. With this information, the row and column headings of the table have been completely specified. A cell is now defined by a particular partial assignment. The result that needs to be displayed is taken from the truth-table, in the row that satisfies that partial assignment. Finally, tiers with identical results can be combined. For example, instead of having two rows labeled “Formulary and DAW=2” and “Formulary and DAW=5” with identical results, we create a single row called “Formulary and (DAW=2 or DAW=5).”

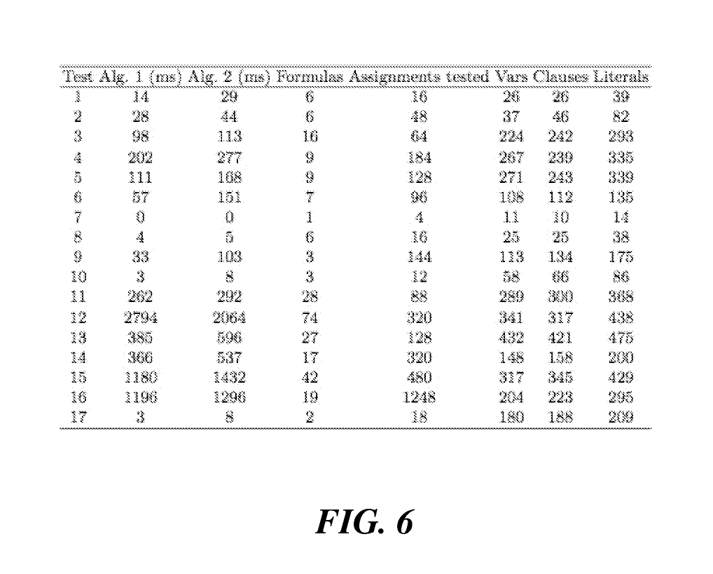

Referring to FIG. 6, Algorithms 1 and 2 were applied to 17 sample policies and the related statistics were collected. As shown, Algorithm 1 was faster than Algorithm 2 for 15 out of the 17 policies. Algorithm 2 called the SAT solver twice in an iteration, as opposed to one call in Algorithm 1. However, Algorithm 2 called the SAT solver on smaller formulas, because of the optimization of Lemma 1. The results indicate that this optimization was not helpful in most cases, probably because it eliminated redundant clauses and the SAT solver is not much affected by those. On small tests, Algorithm 1 was significantly faster; however, it is about 5% faster over the tests combined. Algorithm 1 was much slower on test 12, which is the longest.

Analysis of the run-times of the summarization algorithms showed that the number of formulas and number of assignments affect the execution length of an algorithm. For example, since the algorithms run over the formulas for an assignment until a termination condition is reached, the multiplication of the number of formulas by the number of assignments accounts for most of the variability in the run-times.

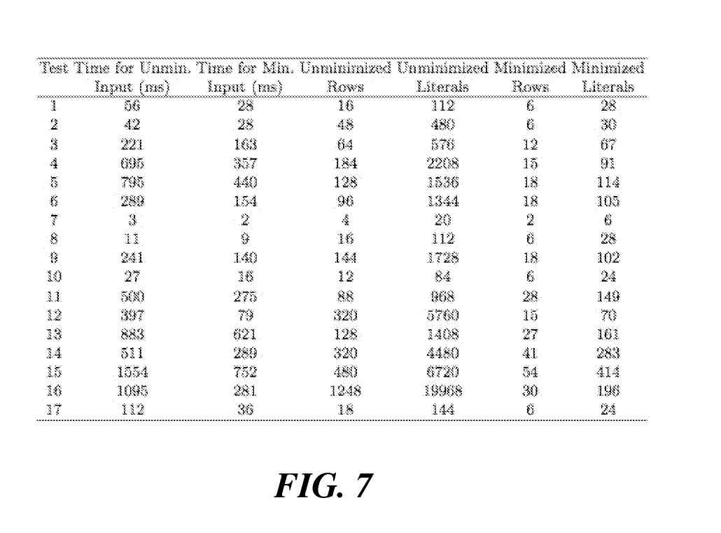

Referring to FIG. 7, in order to determine the effects of the different parameters on the output-creation stage, measurements were gathered when the input was unminimized, and when the input was already minimized. This latter case serves as a sort of baseline in determining performance While the input is significantly larger than the output (often orders of magnitude larger, as can be seen by comparing the numbers of unminimized rows and literals to their minimized counterparts), the run times for the actual (unminimized) input are about 2-5 times as large as the run times for the minimized input.

According to the above example, the overall run-time is dependent on the output size from the minimization, but much less so on the input size because in the minimization algorithm for a row in the table the literals are eliminated one at a time by turning values of 1 and 0 into * and validating that the elimination is legal (i.e., no contradictions are introduced). Once we have eliminated as many literals as we can, we then check if other rows in the table are covered by the row; if so, they can be eliminated. We conjecture that the time taken to check whether the other rows in the table are covered is insignificant compared to the time spent eliminating the literals. Thus, if we consider the run-time normalized by the average number of literals per row, there should be a small difference between the unminimized and minimized inputs.

The above provided systems and methods support claims-adjudication systems written as a set of rules to be evaluated sequentially. There is a great variety of such systems in active use; some are less complex than this decision-table format, while others are closer to a general-purpose programming language. Depending on implementation, the definition of the most general rule may need to be replaced by a more semantic (and more complex) one.

One heuristic that may be used, for example, is to assume that a test for any particular drug will be false in the general case, since it is a special rather than a general case. When applied to drug groups, “generic” may be considered to be a drug group, but it may not be determinable whether generic or brand is the general case. This particular scenario is unlikely to occur in practice, since the related variable is likely to be an interesting one.

It is noteworthy that if a program has variables that are modified during a run, where the program determines its flow based on these variables (as opposed to using the variables to compute the final outcome), using a SAT solver as described above may be challenging. As such, it is desirable to generalize the results to more complex systems by developing a reasonable definition of the most general result, and accordingly modifying the algorithm to compute it.

In some embodiments, the algorithm's performance may be improved by gradually expanding assignments as we progress from formula to formula, encountering new interesting variables, rather than generating the partial assignments for the interesting variables in the policy. Such approach may result in fewer assignments being generated and a smaller truth-table for output-creation. Further, in some embodiments, other methods or mechanisms may be used to compute the summary For example, the policy may be represented as a control-flow graph and feasible sets of assignments may be propagated on the control-flow graph using static analysis techniques for programs such as abstract interpretation.

References in this specification to “an embodiment”, “one embodiment”, “one or more embodiments” or the like, mean that the particular element, feature, structure or characteristic being described is included in at least one embodiment of the disclosed subject matter. Occurrences of such phrases in this specification should not be particularly construed as referring to the same embodiment, nor should such phrases be interpreted as referring to embodiments that are mutually exclusive with respect to the discussed features or elements.

In different embodiments, the claimed subject matter may be implemented as a combination of both hardware and software elements, or alternatively either entirely in the form of hardware or entirely in the form of software. Further, computing systems and program software disclosed herein may comprise a controlled computing environment that may be presented in terms of hardware components or logic code executed to perform methods and processes that achieve the results contemplated herein. Said methods and processes, when performed by a general purpose computing system or machine, convert the general purpose machine to a specific purpose machine.

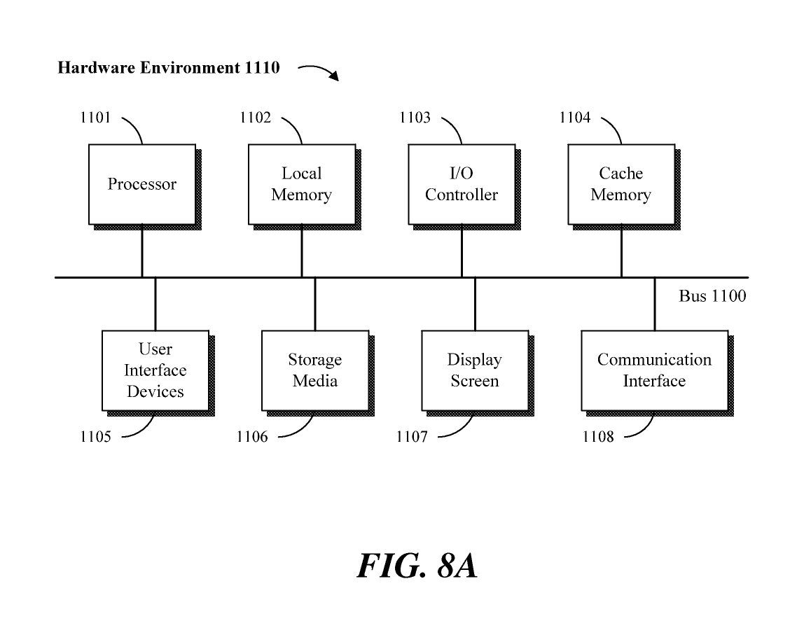

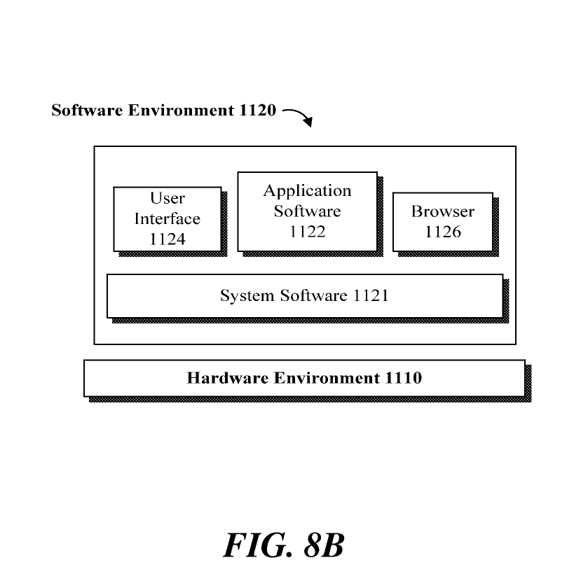

Referring to FIGS. 8A and 8B, a computing system environment in accordance with an exemplary embodiment may be composed of a hardware environment 1110 and a software environment 1120. The hardware environment 1110 may comprise logic units, circuits or other machinery and equipments that provide an execution environment for the components of software environment 1120. In turn, the software environment 1120 may provide the execution instructions, including the underlying operational settings and configurations, for the various components of hardware environment 1110.

Referring to FIG. 8A, the application software and logic code disclosed herein may be implemented in the form of machine readable code executed over one or more computing systems represented by the exemplary hardware environment 1110. As illustrated, hardware environment 110 may comprise a processor 1101 coupled to one or more storage elements by way of a system bus 1100. The storage elements, for example, may comprise local memory 1102, storage media 1106, cache memory 1104 or other machine-usable or computer readable media. Within the context of this disclosure, a machine usable or computer readable storage medium may include any recordable article that may be utilized to contain, store, communicate, propagate or transport program code.

A computer readable storage medium may be an electronic, magnetic, optical, electromagnetic, infrared, or semiconductor medium, system, apparatus or device. The computer readable storage medium may also be implemented in a propagation medium, without limitation, to the extent that such implementation is deemed statutory subject matter. Examples of a computer readable storage medium may include a semiconductor or solid-state memory, magnetic tape, a removable computer diskette, a random access memory (RAM), a read-only memory (ROM), a rigid magnetic disk, an optical disk, or a carrier wave, where appropriate. Current examples of optical disks include compact disk, read only memory (CD-ROM), compact disk read/write (CD-R/W), digital video disk (DVD), high definition video disk (HD-DVD) or Blue-ray™ disk.

In one embodiment, processor 1101 loads executable code from storage media 1106 to local memory 1102. Cache memory 1104 optimizes processing time by providing temporary storage that helps reduce the number of times code is loaded for execution. One or more user interface devices 1105 (e.g., keyboard, pointing device, etc.) and a display screen 1107 may be coupled to the other elements in the hardware environment 1110 either directly or through an intervening I/O controller 1103, for example. A communication interface unit 1108, such as a network adapter, may be provided to enable the hardware environment 1110 to communicate with local or remotely located computing systems, printers and storage devices via intervening private or public networks (e.g., the Internet). Wired or wireless modems and Ethernet cards are a few of the exemplary types of network adapters.

It is noteworthy that hardware environment 1110, in certain implementations, may not include some or all the above components, or may comprise additional components to provide supplemental functionality or utility. Depending on the contemplated use and configuration, hardware environment 1110 may be a machine such as a desktop or a laptop computer, or other computing device optionally embodied in an embedded system such as a set-top box, a personal digital assistant (PDA), a personal media player, a mobile communication unit (e.g., a wireless phone), or other similar hardware platforms that have information processing or data storage capabilities.

In some embodiments, communication interface 1108 acts as a data communication port to provide means of communication with one or more computing systems by sending and receiving digital, electrical, electromagnetic or optical signals that carry analog or digital data streams representing various types of information, including program code. The communication may be established by way of a local or a remote network, or alternatively by way of transmission over the air or other medium, including without limitation propagation over a carrier wave.

As provided here, the disclosed software elements that are executed on the illustrated hardware elements are defined according to logical or functional relationships that are exemplary in nature. It should be noted, however, that the respective methods that are implemented by way of said exemplary software elements may be also encoded in said hardware elements by way of configured and programmed processors, application specific integrated circuits (ASICs), field programmable gate arrays (FPGAs) and digital signal processors (DSPs), for example.

Referring to FIG. 8B, software environment 1120 may be generally divided into two classes comprising system software 1121 and application software 1122 as executed on one or more hardware environments 1110. In one embodiment, the methods and processes disclosed here may be implemented as system software 1121, application software 1122, or a combination thereof. System software 1121 may comprise control programs, such as an operating system (OS) or an information management system, that instruct one or more processors 1101 (e.g., microcontrollers) in the hardware environment 1110 on how to function and process information. Application software 1122 may comprise but is not limited to program code, data structures, firmware, resident software, microcode or any other form of information or routine that may be read, analyzed or executed by a processor 1101.

In other words, application software 1122 may be implemented as program code embedded in a computer program product in form of a machine-usable or computer readable storage medium that provides program code for use by, or in connection with, a machine, a computer or any instruction execution system. Moreover, application software 1122 may comprise one or more computer programs that are executed on top of system software 1121 after being loaded from storage media 1106 into local memory 1102. In a client-server architecture, application software 1122 may comprise client software and server software. For example, in one embodiment, client software may be executed on a client computing system that is distinct and separable from a server computing system on which server software is executed.

Software environment 1120 may also comprise browser software 1126 for accessing data available over local or remote computing networks. Further, software environment 1120 may comprise a user interface 1124 (e.g., a graphical user interface (GUI)) for receiving user commands and data. It is worthy to repeat that the hardware and software architectures and environments described above are for purposes of example. As such, one or more embodiments may be implemented over any type of system architecture, functional or logical platform or processing environment.

It should also be understood that the logic code, programs, modules, processes, methods and the order in which the respective processes of a method are performed are purely exemplary. Depending on implementation, the processes or any underlying sub-processes and methods may be performed in any order or concurrently, unless indicated otherwise in the present disclosure. Further, unless stated otherwise with specificity, the definition of logic code within the context of this disclosure is not related or limited to any particular programming language, and may comprise one or more modules that may be executed on one or more processors in distributed, non-distributed, single or multiprocessing environments.

As will be appreciated by one skilled in the art, a software embodiment may include firmware, resident software, micro-code, etc. Certain components including software or hardware or combining software and hardware aspects may generally be referred to herein as a “circuit,” “module” or “system.” Furthermore, the subject matter disclosed may be implemented as a computer program product embodied in one or more computer readable storage medium(s) having computer readable program code embodied thereon. Any combination of one or more computer readable storage medium(s) may be utilized. The computer readable storage medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing.

In the context of this document, a computer readable storage medium may be any tangible medium that can contain, or store a program for use by or in connection with an instruction execution system, apparatus, or device. A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable storage medium may be transmitted using any appropriate medium, including but not limited to wireless, wireline, optical fiber cable, RF, etc., or any suitable combination of the foregoing. Computer program code for carrying out the disclosed operations may be written in any combination of one or more programming languages, including an object oriented programming language such as Java, Smalltalk, C++ or the like and conventional procedural programming languages, such as the “C” programming language or similar programming languages.

The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Certain embodiments are disclosed with reference to flowchart illustrations or block diagrams of methods, apparatus (systems) and computer program products according to embodiments. It will be understood that a block of the flowchart illustrations or block diagrams, and combinations of blocks in the flowchart illustrations and/or block diagrams, can be implemented by computer program instructions. These computer program instructions may be provided to a processor of a general purpose computer, a special purpose machinery, or other programmable data processing apparatus to produce a machine, such that the instructions, which execute via the processor of the computer or other programmable data processing apparatus, create means for implementing the functions or acts specified in the flowchart or block diagram block or blocks.

These computer program instructions may also be stored in a computer readable storage medium that can direct a computer, other programmable data processing apparatus, or other devices to function in a particular manner, such that the instructions stored in the computer readable storage medium produce an article of manufacture including instructions which implement the function or act specified in the flowchart or block diagram block or blocks.

The computer program instructions may also be loaded onto a computer, other programmable data processing apparatus, or other devices to cause a series of operational steps to be performed on the computer, other programmable apparatus or other devices to produce a computer or machine implemented process such that the instructions which execute on the computer or other programmable apparatus provide processes for implementing the functions or acts specified in the flowchart or block diagram block or blocks.

The flowchart and block diagrams in the figures illustrate the architecture, functionality, and operation of possible implementations of systems, methods and computer program products according to various embodiments. In this regard, a block in the flowchart or block diagrams may represent a module, segment, or portion of code, which comprises one or more executable instructions for implementing the specified logical functions. It should also be noted that, in some alternative implementations, the functions noted in the block may occur in any order or out of the order noted in the figures.

For example, two blocks shown in succession may, in fact, be executed substantially concurrently, or the blocks may sometimes be executed in the reverse order, depending upon the functionality involved. It will also be noted that a block of the block diagrams or flowchart illustration, and combinations of blocks in the block diagrams or flowchart illustration, may be implemented by special purpose hardware-based systems that perform the specified functions or acts, or combinations of special purpose hardware and computer instructions.

The claimed subject matter has been provided here with reference to one or more features or embodiments. Those skilled in the art will recognize and appreciate that, despite of the detailed nature of the exemplary embodiments provided here, changes and modifications may be applied to said embodiments without limiting or departing from the generally intended scope. These and various other adaptations and combinations of the embodiments provided here are within the scope of the disclosed subject matter as defined by the claims and their full set of equivalents.

What is claimed is:

1. A computer-implemented method for presenting benefit rules in a policy into a human readable table, the method comprising:
analyzing logic code implemented for processing claims under a policy to identify one or more rules and one or more parameters of interest;
translating the rules, as applicable to the parameters of interest, into an ordered list of boolean expressions;
applying an algorithm to the ordered list of boolean expressions to identify a solution for a set of query parameters defined by the rules and the parameters of interest; and
generating a summary table according to the identified solution for the set of query parameters.

2. The method of claim 1 further comprising minimizing the summary table to generate a minimized summary table.

3. The method of claim 1 wherein a satisfiability (SAT) solver is utilized to identify the solution for the set of query parameters.

4. The method of claim 1 further comprising identifying additional parameters to be added to the set of query parameters in order to produce a more accurate summary table.

5. The method of claim 1 wherein the identified solution is found based on applying an algorithm that determines a most general solution for the set of query parameters.

6. The method of claim 5, wherein the most general solution is determined independent of language or architecture in which the benefit rules in the logic code are implemented.

7. The method of claim 1 wherein the parameters of interest are provided by way of user input.

8. The method of claim 1 wherein in the solution for the set of query parameters is found by way of a constraint satisfaction problem.

9. The method of claim 1 wherein the rules are benefit rules in a coverage policy that defines what benefits a member covered by the coverage policy is entitled to.

10. The method of claim 9 wherein the coverage policy is related to healthcare coverage for groups or individuals.

11. A computer-implemented system for presenting benefit rules in a policy into a human readable table, the system comprising:
a logic unit for analyzing logic code implemented for processing claims under a policy to identify one or more rules and one or more parameters of interest;
a logic unit for translating the rules, as applicable to the parameters of interest, into an ordered list of Boolean expressions;
a logic unit for applying an algorithm to the ordered list of Boolean expressions to identify a solution for a set of query parameters defined by the rules and the parameters of interest; and
a logic unit for generating a summary table according to the identified solution for the set of query parameters.

12. The system of claim 1 further comprising a logic unit for minimizing the summary table to generate a minimized summary table.

13. The system of claim 1 wherein a satisfiability (SAT) solver is utilized to identify the solution for the set of query parameters.

14. The system of claim 1 further a logic unit for comprising identifying additional parameters to be added to the set of query parameters in order to produce a more accurate summary table.

15. The system of claim 1 wherein the identified solution is found based on applying an algorithm that determines a most general solution for the set of query parameters.

16. The system of claim 5, wherein the most general solution is determined independent of language or architecture in which the benefit rules in the logic code are implemented.

17. The system of claim 1 wherein the parameters of interest are provided by way of user input.

18. The system of claim 1 wherein in the solution for the set of query parameters is found by way of a constraint satisfaction problem.

19. The system of claim 1 wherein the rules are benefit rules in a coverage policy that defines what benefits a member covered by the coverage policy is entitled to.

20. The system of claim 19 wherein the coverage policy is related to healthcare coverage for groups or individuals.

21. A computer program product comprising a non-transitory data storage medium having a computer readable program, wherein the computer readable program when executed on a computer causes the computer to:
analyze logic code implemented for processing claims under a policy to identify one or more rules and one or more parameters of interest;
translate the rules, as applicable to the parameters of interest, into an ordered list of boolean expressions;
apply an algorithm to the ordered list of boolean expressions to identify a solution for a set of query parameters defined by the rules and the parameters of interest; and
generate a summary table according to the identified solution for the set of query parameters.

22. The computer program product of claim 21, wherein the computer readable program when executed on a computer further causes the computer to minimize the summary table to generate a minimized summary table.

23. The computer program product of claim 21, wherein a satisfiability (SAT) solver is utilized to identify the solution for the set of query parameters.

24. The computer program product of claim 21, wherein the identified solution is found based on applying an algorithm that determines a most general solution for the set of query parameters.

25. The computer program product of claim 21, wherein the most general solution is determined independent of language or architecture in which the benefit rules in the logic code are implemented.
